(19) United States
(12) Patent Application Publication
(10) Pub. No.: US 2020/0016604 A1
(43) Pub. Date: Jan. 16, 2020

(54) DEVICE FOR COMMINUTING AND DRYING WASTE MATERIALS, SLAGS, ROCKS AND SIMILAR MATERIALS

(71) Applicant: LPT AG, Ruggell (LI)

(72) Inventor: Egon KOENIG, Ruggell (LI)

(73) Assignee: LPT AG, Ruggell (LI)

(21) Appl. No.: 16/583,992

(22) Filed: Sep. 26, 2019

Related U.S. Application Data
(63) Continuation of application No. PCT/EP2018/053429, filed on Feb. 12, 2018.

(30) Foreign Application Priority Data
Mar. 27, 2017 (CH) 00406/17

(51) Int. Cl. B02C 23/30; B02C 19/06

(52) U.S. Cl. CPC B02C 23/30; B02C 2201/06; B02C 19/061

(57) ABSTRACT

An appliance is disclosed for the size-reduction and drying of waste material. An essentially funnel-shaped vessel has a cylindrical attachment, on which at least two air inlets for introducing compressed air (L) are arranged in a manner distributed over a periphery of the cylindrical attachment, with an exit opening for size-reduced material (G) on a base of the funnel-like vessel. An air outflow opening is larger in diameter than the exit opening and lies opposite the exit opening. An ultrasonic nozzle with a Venturi function arranged on each of the at least two air inlets which are distributed over the periphery of the cylindrical attachment such that fed air (L) will be introduced in a peripheral direction of the cylindrical attachment and of the funnel-shaped vessel.

### RELATED APPLICATION

This application claims priority as a continuation application under 35 U.S.C. § 120 to PCT/EP2018/053429, which was filed as an International Application on Feb. 12, 2018 designating the U.S., and which claims priority to Swiss Application 00406/17 filed in Switzerland on Mar. 27, 2017. The entire contents of these applications are hereby incorporated by reference in their entireties.

### FIELD

The present disclosure relates to an appliance for the size-reduction (comminution) and drying of waste material, slag, rocks and similar materials.

### BACKGROUND INFORMATION

Waste material and similar materials, for the most part are still disposed of in landfill sites. Since landfill sites only have a limited capacity for accommodation, it is desirable to reduce the size of waste material before landfilling. However, the size-reduction of waste material can also be used for processing for energy recovery by way of a subsequent combustion or degassing facility. However, valuable raw materials can also be separated and recovered more easily due to the size-reduction of the waste material or the pulverisation of slag and rock, for example ore rock. One known problem on treating waste material such as for example domestic waste, industrial sludge such as e.g. cement sludge, chalk sludge, industrial and sewage sludge is the relatively high moisture content which is often bound in this waste material. This moisture content which for the most part is very difficult to remove from the waste material, as landfill water represents a problem which should not be underestimated. In combustion facilities, the high moisture content leads to a lower calorific value of the applied waste material. In general, the high moisture content in the waste material as well as the material size has a negative effect upon the energy balance and transport balance (CO₂ emission).

The grinding facilities which are known for the size-reduction of the waste material, have a relatively poor efficiency and are not adequately suitable for reducing the moisture content. A material size-reduction device which includes an essentially funnel-shaped vessel with a cylindrical attachment is known. Compressed air is blown into the cylindrical attachment in the peripheral direction, in order to produce an air vortex within the funnel-shaped vessel. This known appliance can require up to 100 m³ of compressed air per minute, which entails a huge disadvantage for the energy balance and for the economic efficiency of the appliance. Deflection plates which are attached at the entry openings for the compressed air lead the air in the peripheral direction of the vessel.

The material to be reduced in size is conveyed into the cylindrical attachment via a feed conduit and is subjected to the air vortex. The introduced material is to be reduced in size in the air vortex. The deflection plates at the same time serve as impact plates and are to protect the air entry openings from swirling material. The size-reduced material sinks to the floor as a result of gravity and is separated away through an opening on the base of the funnel-shaped vessel. A cylindrical chimney which is arranged on the cylindrical attachment at the opposite end of the vessel which is larger in diameter ensures the discharge of excess air. A certain drying of the introduced material is to be achievable by way of the blown-in air being preheated.

The impact plates are subjected to a high wear and need to be exchanged relatively often. Because material also always impacts against the walls of the funnel-shaped vessel or of the cylindrical attachment, these device components too are subjected to a relatively high wear. The air vortex which can be achieved in the vessel only has a relatively low speed. Accordingly, the appliance only has a relatively low size-reduction effect upon the introduced material.

### SUMMARY

An appliance is disclosed for the size-reduction and drying of waste material, slag, rocks and similar materials (M), the appliance comprising: an essentially funnel-shaped vessel with a cylindrical attachment, on which at least two air inlets for introducing compressed air (L) are arranged in a manner distributed over a periphery of the cylindrical attachment, with an exit opening for size-reduced material (G) on a base of the funnel-like vessel; an air outflow opening which is arranged on the cylindrical attachment at an end of the vessel which is larger in diameter than the exit opening and which lies opposite the exit opening; a feed device for material (M) which is to be reduced in size, the feed device running out into the cylindrical attachment; and an ultrasonic nozzle with a Venturi function arranged on each of the at least two air inlets which are distributed over the periphery of the cylindrical attachment, in a manner such that fed air (L) will be introduced in a peripheral direction of the cylindrical attachment and of the funnel-shaped vessel.

### BRIEF DESCRIPTION OF THE DRAWINGS

Further advantages and embodiments of exemplary methods disclosed will be apparent from the subsequent description of exemplary embodiments with reference to the drawings, which are not true to scale and in which:

FIG. 1 shows a schematic representation of an exemplary appliance according to the present disclosure, in an axial section;

FIG. 2 an enlarged schematic representation of an exemplary ultrasonic nozzle which is fastened to the appliance;

FIG. 3 a perspective view of an exemplary ultrasonic nozzle with a view onto an assembly plate at its inlet side;

FIG. 4 a perspective view of the exemplary ultrasonic nozzle according to FIG. 2 with a view onto the air guidance plate; and

FIG. 5 a perspective view of a further exemplary embodiment.

### DETAILED DESCRIPTION

An appliance is disclosed for the size-reduction and drying of waste material, slag, rocks and similar materials. The appliance can be less prone to wear and permit an adequate size-reduction, even a pulverisation, and/or a drying of the applied waste material. Herein, the appliance can be constructed in an uncomplicated manner and include tried and tested components which are simple in design, and also inexpensive in manufacture and on operation.

A solution as disclosed herein lies in an appliance for the size-reduction and drying of waste material, slag, rocks and similar materials.

An exemplary appliance is disclosed for the size-reduction and drying of waste material, slag, rocks and similar materials, which includes an essentially funnel-shaped vessel with a cylindrical attachment. At least two air inlets which are for introducing compressed and possibly heated air and which are distributed over the periphery are arranged on the cylindrical attachment. The base of the funnel-shaped vessel is provided with an exit opening for size-reduced material. An air outflow opening is arranged on the cylindrical attachment at the end of the vessel which is larger in diameter and which lies opposite the exit opening. A feed device for the material which is to be reduced in size runs out into the cylindrical attachment. A supersonic nozzle with a Venturi system is each arranged on the at least two air inlets which are distributed over the periphery of the cylindrical attachment, in a manner such that the fed air can be introduced in the peripheral direction of the cylindrical attachment and of the funnel-shaped vessel.

Due to the application of supersonic nozzles, the fed, for example, heated air at the entry into the cylindrical attachment on the funnel-shaped vessel reaches very high flow speeds which reach the speed of sound and exceed it by a multiple. By way of this, a heated air vortex is produced in the cylindrical attachment and in particular in the vessel which narrows in a funnel-shaped manner in the direction of its base. The high flow speeds are achieved by the feed of air at a pressure of for example, approx. 4-6 bar. The airflow rates can be for example, approx. 30 to 50 m³/min depending on the height above sea level. For example, these airflow rates can be produced and delivered by way of a controllable, oil-free screw compressor.

A supersonic nozzle is to be understood for example as a nozzle which has a cross-sectional course which corresponds to a Laval nozzle. The design and configuration of the ultrasonic nozzle as a Laval nozzle permits the desired or required amount of air to be significantly reduced, for example by up to 50%. This has a large influence on the positive energy balance. As a result of the high air speeds, the introduced materials are reduced to a high degree, and are even pulverised. As a result of the pulverisation of the applied materials, valuable raw materials which are contained in the materials can be easily recovered again for industry. As a result of the high degree of size-reduction, the loading capacity of transport devices can also be utilised to a greater extent, which again can have a positive effect on the environment (reduction of the CO₂ emission).

The materials which are to be reduced in size get into the produced air vortex with the assistance of a Venturi system and herein undergo an enormous acceleration. Herein, the Venturi system serves for “breaking up” the air vortex which is produced by the ultrasonic nozzles. The materials which are entrained into the air vortex cannot withstand the forces which occur with the sudden acceleration and are therefore broken up into the smallest of constituents. High centrifugal and centripetal forces, shear forces and friction forces which occur within the air vortex, as well as vacuum and cavitation assist in the size-reduction of the materials.

Moisture which is contained in the materials, for example water which is contained in sewage sludge and industrial sludge and is bound in the solid-matter particles is herein separated and transported away with the air which is heated in the air vortex, through the air exit openings which can be arranged on an adjustable chimney-like continuation. The temperature of the outgoing air can be for example up to 100° C. A constant airflow can be produced in the appliance by way of the arrangement of at least two ultrasonic nozzles and this airflow results in an air vortex which breaks away from the inner wall of the appliance. An impacting of the materials upon the inner walls of the cylindrical attachment and of the funnel-shaped vessel can be prevented by way of this.

An exemplary embodiment of the appliance as disclosed can envisage the ultrasonic nozzles with the Venturi system which are arranged on the air inlets being arranged at the same axial height of the cylindrical attachment on the funnel-shaped vessel. The uniformity of the air vortex can be improved by way of this and greater flow speeds can be achieved given a constant energy input.

Concerning an exemplary embodiment variant of the appliance, the ultrasonic nozzles can enable an outlet which has a cross section which is different from the circular shape. The tangential and vertical components of the airflow can be improved in the context of a better production of the air vortex by way of the selection of the flow cross section at the outlet.

An exemplary embodiment can envisage the cross section of the outlet of the ultrasonic nozzles being designed in a rectangular manner. By way of this, the occurrence of cavitation and a vacuum is encouraged in the inside of the produced air vortex.

Concerning a further exemplary embodiment of the appliance, the ultrasonic nozzles each include a narrowest throughflow cross section which can be configured to be changeable when desired or required. The flow speeds at the exit of the ultrasonic nozzles can be influenced in a targeted manner by way of the change of the flow cross section. The adjusting screws or similar mechanical adjusting means can be arranged in a manner such that they are also accessible to the user during operation of the appliance.

The change of at least the narrowest throughflow cross section of the ultrasonic nozzles can be effected mechanically, for example via adjusting screws or the like. A useful exemplary embodiment can envisage the narrowest throughflow cross section of the ultrasonic nozzle being automatically adjustable via servomotors. The motoric adjustability permits an adjustment of the narrowest throughflow cross section of the nozzles without having for example to open or even disassemble a housing which accommodates the funnel-shaped vessel and the cylindrical attachment.

In combination with a motoric adjustability, the narrowest throughflow cross section of the ultrasonic nozzles can be controllable in dependence on the applied material which is to be reduced in size. Herein, the control data, for example in tabular form, can be stored in an external control unit which is connected to the appliance. The control data for adjusting the narrowest throughflow cross section of the nozzles can be determined and compiled empirically. An exemplary embodiment can permit the user of the appliance to select the correct control data for the adjustment of the ultrasonic nozzles in dependence on the applied material. The control unit can, for example, include an electronic data processing unit. The parameter acquisition, parameter control and their selection can be simplified by way of this.

A further exemplary embodiment can envisage the ultrasonic nozzles on the air inlets on the cylindrical attachment each running out into an air guidance plate which is inserted into a recess in the inner wall of the cyclical attachment. The air guidance plate limits the outlet of the ultrasonic nozzle and is assembled in a manner such that it projects beyond the inner wall of the cylindrical attachment at least in the region of the outlet. The fed compressed air is introduced tangentially along the inner periphery of the cylindrical attachment by way of this.

Concerning an exemplary embodiment of the appliance according to the disclosure, the air guidance plates can be rotatable by for example, 180° with respect to a nozzle body of the ultrasonic nozzle. By way of this, the appliance can be adapted very simply with regard to different conditions in the earth's northern hemisphere and southern hemisphere. Whilst an air vortex which is cyclonal, i.e. which rotates in the anti-clockwise direction can be useful in the northern hemisphere, an anti-cyclonal air vortex in the appliance tends to be desirable in the southern hemisphere. The efficiency of the appliance with regard to the size-reduction and the drying can be improved by way of this. For this, an exemplary embodiment can envisage the air guidance plate being fixedly connected to an assembly plate and the nozzle body of the ultrasonic nozzle being able to be flanged on the assembly plate. The assembly plate serves for the assembly of the ultrasonic nozzle on the outer wall of the cylindrical attachment. The nozzle body can be flanged onto the assembly plate in two positions which are rotated by 180°. The position of the ultrasonic nozzle and the air feeds with regard to the periphery of the cylindrical attachment can remain unchanged by way of this.

In an alternative exemplary embodiment, the air guidance plate, the assembly plate and the nozzle body can however also be rigidly connected to one another. The complete ultrasonic nozzle unit can then be rotated together with the assembly plate and the air guidance plate by 180° for changing the rotation direction of the produced air vortex.

A further exemplary embodiment of the appliance can be connected to a control device which is connected to a global network, for example a wide area network such as the Internet, in a manner such that the operating parameters of the appliance can be remotely read off and the appliance is for example, remote-controllable. The connection of the control device, which can also encompass the control unit for the cross-sectional change of the ultrasonic nozzles, to the Internet can be utilised for example for service purposes, for remote diagnoses and for the remote control of the appliance.

Yet a further exemplary embodiment of the appliance can envisage more than two ultrasonic nozzles being arranged on the periphery of the cylindrical attachment at the same angular distance to one another. The number of desired or necessary ultrasonic nozzles can be selected in dependence on the size and the diameter of the funnel-shaped vessel together with the cylindrical attachment, in order to optimise the flow speed in the produced air vortex.

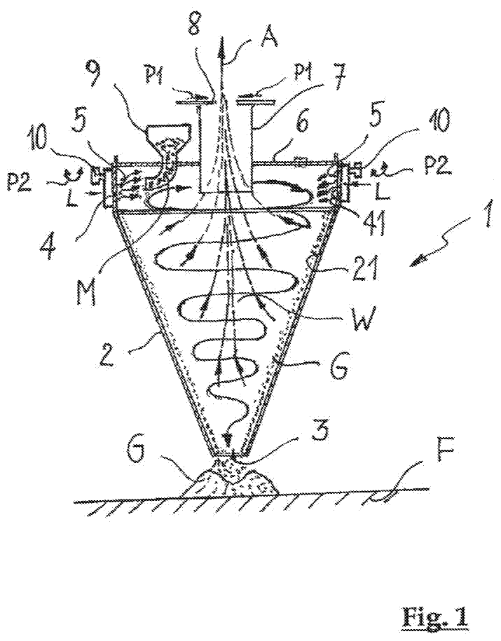

An appliance according to the present disclosure, which is represented in the axial section entirety is provided in its entirety with the reference numeral 1. The appliance includes a funnel-shaped vessel 2 with an exit opening 3. The funnel-shaped vessel 2 at its end which is away from the exit opening 3 includes a cylindrical attachment 4. At least two air inlets 5 for compressed or possibly heated air are provided on the cylindrical attachment 4 and are distributed over the periphery of the cylindrical attachment 4. A chimney 7 which projects through a cover 6 into the cylindrical attachment 4 includes an air outflow opening. The cross section of the air outflow opening on the chimney 7 can be changed when desired or necessary, which is indicated in FIG. 1 by an adjustable aperture 8 and the arrows P1. A feed device 9 for material M which is to be reduced in size (comminuted) and dried passes through the cover 6 and projects into the cylindrical attachment 4.

An ultrasonic nozzle 10 is each arranged on the at least two air inlets 5 which are distributed over the periphery of the cylindrical attachment 4. Compressed and possibly heated air L is led into the cylindrical attachment 4 via the ultrasonic nozzles 10. An ultrasonic nozzle 10 according to the present disclosure is to be understood as a nozzle which for example has a cross-sectional course which corresponds to a Laval nozzle. On account of the application of ultrasonic nozzles 10, the fed, preferably heated air L has very high flow speeds at the entry into the cylindrical attachment 4 and into the funnel-shaped vessel 2, these reaching the speed of sound and can even exceed this by a multiple. On account of this, a heated air vortex W is produced in the cylindrical attachment 4 and in particular in the vessel 2 which narrows in a funnel-shaped manner in the direction of its outlet opening 3.

The high flow speeds are achieved by the feed of air L at a pressure of for example, approx. (e.g., ±10%) 4-6 bar. Herein, the throughput flow rates can be approx (e.g., ±10%) 30 to 50 m³/min depending on the height above sea level. For example, these airflow rates can be produced and delivered by way of a controllable oil-free screw compressor. The rotation direction of the air vortex W which is produced in the appliance 1 is adaptable depending on the installation location in the northern or the southern hemisphere. Whereas a cyclonal air vortex, i.e. one which rotates in the anti-clockwise direction been found to be useful in the northern hemisphere, an anti-cyclonal air vortex in the appliance tends to be more desirable in the southern hemisphere. For this, the inflow direction of the ultrasonic nozzles 10 at the air inlets 5 is changeable, in particular rotatable by for example, 180°. This is indicated in FIG. 1 by the arcuate arrows P2.

The materials M which are to be reduced in size and which are introduced into the appliance 1 via the feed device 9 are introduced into the produced air vortex with the assistance of a Venturi system which is provided on the ultrasonic nozzles 10. Herein, the Venturi system serves for briefly “breaking up” the air vortex W which is produced by the ultrasonic nozzles 10. The materials M which are introduced into the air vortex W are very greatly accelerated directly after the release into the air vortex. The materials M are not able to withstand the forces which occur given the sudden acceleration and are therefore broken up into smaller constituents. High centrifugal and centripetal forces, shear forces and friction forces as well as the vacuum and cavitation which occur within the air vortex assist in the size-reduction of the materials M. Moisture which is contained in the materials M, for example water which is contained in sewage sludge and industrial sludge and is bound in the solid-matter particles is herein separated away and is transported away with the outgoing air A which heats up in the air vortex W, through the chimney-like air outlet 7 whose outlet cross section can be adjustable. The temperature of the outgoing air A can be for example up to 100° C.

A uniform airflow is produced in the appliance 1 by way of the arrangement of at least two ultrasonic nozzles 10 with a Venturi function, the airflow resulting in an air vortex W which breaks away from the inner walls of the appliance 1. By way of this, an impacting of the materials M onto the inner walls 41 and 21 of the cylindrical attachment 4 and of the funnel-shaped vessel 2 respectively can be prevented. The material which is reduced in size (comminuted), as a granulate goes along the inner wall 21 of the funnel-shaped vessel 2 to the exit opening 3 of the appliance and trickles to the floor. This is indicated in FIG. 1 by a pile of granulate G on the floor F.

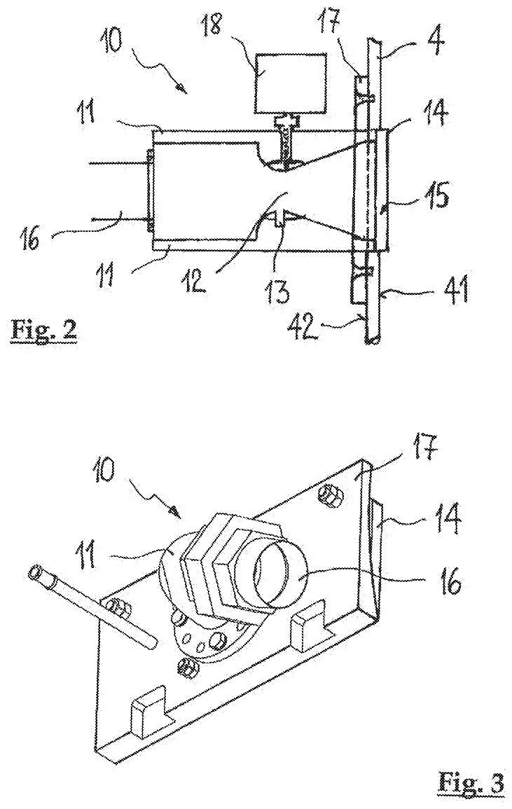

FIG. 2 schematically shows an axial section of an ultrasonic nozzle 10 which is assembled on the cylindrical attachment 4. The ultrasonic nozzle 10 for example roughly has the cross-sectional course of a Laval nozzle. At the entry side, the ultrasonic nozzle 10 is connected to an air feed conduit 16. The airflow rates which are desired or necessary for producing the air vortex are produced and delivered for example by way of a controllable, oil-free screw compressor. The ultrasonic nozzle 10 includes a nozzle body 11 which is designed for example in a multi-part manner.

The parts of the nozzle body 11 are connected to one another in a manner such that they are adjustable to one another, in order to be able to change at least a narrowest throughflow cross section 12 of the ultrasonic nozzle 10. The adjustment of the parts of the nozzle 11 to one another can be effected for example via one or more adjusting screws.

In the schematically represented embodiment example, a motoric adjustability of the narrowest throughflow cross section 12 is indicated with the help of a servomotor 18. The motoric adjustability permits an automatic adjustment of the narrowest throughflow cross section 12 of the ultrasonic nozzle 10 without having for example to open or even dismantle a housing which accommodates the funnel-shaped vessel and the cylindrical attachment.

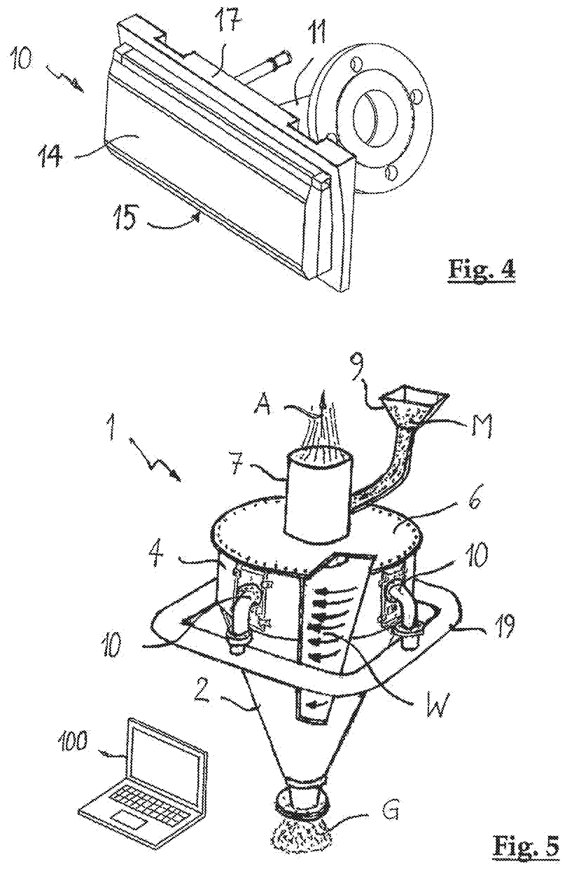

In combination with a motoric adjustability, the narrowest throughflow cross section 12 of the ultrasonic nozzle can be configured controllable in dependence on the applied material which is to be reduced in size. Herein, the control data can for example, be stored in a tabular manner, in an external control unit which is in connection with the appliance. The control data for adjusting the narrowest throughflow cross section 12 of the ultrasonic nozzle 10 can be determined and compiled empirically. An advantageous exemplary embodiment can permit the user of the appliance to select the correct control data for the adjustment of the ultrasonic nozzles 10 in dependence on the applied material. The control unit can for example, include an electronic data processing facility (FIG. 4). The acquisition, control and the selection of the parameters can be simplified by way of this.

The ultrasonic nozzle 10 can have a Venturi function. For this purpose, a Venturi bore 13 which when desired or required can be opened and closed again is arranged at the narrowest throughflow cross section 12 of the nozzle body 11. Surrounding air is sucked into the ultrasonic nozzle 10 by way of opening the Venturi bore 13. The airflow within the ultrasonic nozzle 10 is upset by way of this. This effect can be used to “break up” the air vortex which is produced within the funnel-shaped vessel and the cylindrical attachment by way of the inflowing air, in a targeted manner, in order for example to feed materials into the air vortex.

The nozzle body 11 of the ultrasonic nozzle 10 runs out into air guidance plate 14 which in the assembled state terminates with the inner wall 41 of the cylindrical attachment 4 in an essentially flush manner. The air guidance plate 14 is inserted into the air inlet 5 of the cylindrical attachment in a manner such that it projects beyond the inner wall 41 of the cylindrical attachment 4 at least in the region of the air outlet 15 of the ultrasonic nozzle 10. By way of this, the compressed air can be introduced essentially tangentially along the inner wall 41 of the cylindrical attachment 4. The air outlet 15 which is delimited by the air guidance plate 14 has a cross section which deviates from the circular shape. For example, the air outlet 15 has an essentially rectangular cross section. The tangential and vertical components of the airflow can be influenced in the context of an improved production of the air vortex by way of the flow cross section at the outlet being different from the circular shape. By way of this, the occurrence of cavitation and a vacuum can be encouraged.

The nozzle body 11 is connected to an assembly plate 17 for the assembly of the ultrasonic nozzle 10 on the cylindrical attachment 4. The assembly plate 17 is connected to the air guidance plate 14 and is arranged in a manner such the air guidance plate 14 projects beyond it in the airflow direction. The assembly plate 17 is fastened to an outer wall 42 of the cylindrical attachment 4 by way of for example, screws or the like.

The assembly plate 17 and the air guidance plate 14 which is connected to this can be rigidly connected to the nozzle body 11. The complete ultrasonic nozzle unit together with the nozzle body 11, assembly plate 17 and air guidance plate 14 must then be rotated by for example, 180° for changing the rotation direction of the air vortex which is produced in the appliance. The assembly plate 17 and the air guidance plate 14 which is connected to this can however also be rotatable by 180° with respect to the nozzle body 11 as is particularly represented in FIG. 3. For this, the nozzle body 11 can be unflanged from the assembly plate 17 and after the rotation and assembly of the assembly plate 17 and the air guidance plate 14 can be flanged onto the cylindrical attachment again. The position of the ultrasonic nozzle 10 and of the air feeds in relation to the periphery of the cylindrical attachment 4 can remain unchanged due to the rotatability of the nozzle body 1 with respect to the assembly plate 17 and the air guidance plate 14.

FIG. 3 shows a perspective view of an exemplary ultrasonic nozzle 10 according to the disclosure, with a view onto the assembly plate 17. The same components have the same reference numerals as in FIG. 2. The nozzle body 11 is flanged onto the assembly plate 17. The air feed conduit 16 is indicated at the entry-side end of the ultrasonic nozzle 10. The air guidance plate 14 which in the assembled state of the ultrasonic nozzle 10 terminates with the inner wall of the cylindrical attachment in an essentially flush manner projects beyond the assembly plate 17 in the airflow direction.

FIG. 4 shows the ultrasonic nozzle according to FIG. 2 in a perspective view with a view onto the air guidance plate 14. The assembly plate again has the reference numeral 17. It is evident from the figure that the side of the assembly plate 17 which faces the air guidance plate 14 is designed and configured in a concavely arcuate manner, in order to follow the curvature of the cylindrical attachment. The air outlet 15 of the ultrasonic nozzle 10 is arranged at the side of the air guidance plate 14 which is away from the viewer. It has a cross section which differs from the circular shape. It is for example, designed and configured in an essentially rectangular manner. The nozzle body of the ultrasonic nozzle 10 is indicated by the reference numeral 11.

FIG. 5 shows a schematic, perspective representation of a further exemplary embodiment of an appliance according to the disclosure, for the size-reduction (comminution) and drying of waste material and similar materials which again in its entirely has the reference numeral 1. The same constituents of the appliance 1 are provided with the same reference numerals as in FIG. 1. The appliance again includes a funnel-shaped vessel 2 with an exit opening 3. At its end which is away from the exit opening 2, the funnel-shaped vessel 2 is connected to the cylindrical attachment 4. Ultrasonic nozzles 10 for compressed and possibly heated air are assembled on the cylindrical attachment 4 and are for example, distributed over the periphery of the cylindrical attachment 4 at the same angular distance to one another. Concerning the shown exemplary embodiment, for example, four ultrasonic nozzles 10 are provided, of which two are visible in the figure. The ultrasonic nozzles 10 are assembled at the same height of the cylindrical attachment 4. A chimney-like continuation 7 whose exit cross section can be adjustable projects through the cover 6 which closes the cylindrical attachment. A feed device 9 for materials M which are to be reduced in size and dried passes through the cover 6 and likewise projects into the cylindrical attachment 4.

The ultrasonic nozzles 10 are connected to a roughly annularly running air feed conduit 19 which for its part can be connected for example to an oil-free screw compressor via a further air conduit (not represented). Herein, the air feed conduits can be designed and configured according to the Tichelmann system. This means that the pressure loss coefficients of the feed conduits to the individual ultrasonic nozzles 10 are the same for all ultrasonic nozzles, so that a uniform throughflow is ensured. The pressure losses of the feed conduits are essentially composed of the pipe friction, i.e. the inner roughness, the diameter and the length and the pressure-loss coefficients of the pipe elements. The pressure loss coefficients of the pipe elements can be determined empirically and can usually be derived from the literature.

The air can be fed to the ultrasonic nozzles 10 at a pressure of, for example, approx. 4-6 bar and with a volume of, for example, 30 to 50 m³/min with the help of the controllable, oil-free screw compressor. The ultrasonic nozzles 10 permit flow speeds which exceed the speed of sound. By way of this, an air vortex is produced within the appliance 1, the air vortex in the partly sectioned representation of the appliance 1 in FIG. 4 1 again being provided with the reference numeral W.

The materials M which are brought into the appliance 1 via the feed device 9 and which are to be reduced in size are entrained into the produced air vortex and are accelerated to a high degree directly after release into the air vortex W. The materials M cannot withstand the forces which occur with the sudden acceleration and are therefore broken down into smaller constituents. High centrifugal and centripetal forces, shear and friction forces as well as vacuum and cavitation which occur within the air vortex W assist in the size-reduction, for example pulverisation of the materials M. Moisture which is contained in the materials M, for example water which is contained in sewage sludge and is bound in the solid-matter particles is herein separated and is transported away with the outgoing air A which is heated in the air vortex W, through the chimney-like air outlet 7. The temperature of the outgoing air A can be for example up to 100° C. The air vortex W which is produced in the appliance breaks away from the inner walls of the appliance 1. On account of this, an impacting of the materials M onto the inner walls of the cylindrical attachment 4 or of the funnel-shaped vessel 2 can be prevented. The material which is reduced in size, as a granulate G, gets to the exit opening 3 of the appliance and trickles to the base.

The appliance 1 for the size-reduction and drying of waste material, slag, rocks and similar materials can be connected to a control device which is indicated by the reference numeral 100. The control device 100 can be connected to a global computer network, for example to the internet, in a manner such that the operating parameters of the appliance can be remotely read and the appliance can for example, be remote controlled. The connection of the control device 100 which can also encompass the control unit for a cross-sectional change of the ultrasonic nozzles 10, to the internet, can be utilised for example for service purposes, for remote diagnoses and for the remote control of the appliance.

The above description of specific embodiment examples serves merely for explanation of the invention and is not to be considered as restricting.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. An appliance for the size-reduction and drying of waste material, slag, rocks and similar materials (M), the appliance comprising:
an essentially funnel-shaped vessel with a cylindrical attachment, on which at least two air inlets for introducing compressed air (L) are arranged in a manner distributed over a periphery of the cylindrical attachment, with an exit opening for size-reduced material (G) on a base of the funnel-like vessel;
an air outflow opening which is arranged on the cylindrical attachment at an end of the vessel which is larger in diameter than the exit opening and which lies opposite the exit opening;
a feed device for material (M) which is to be reduced in size, the feed device running out into the cylindrical attachment; and
an ultrasonic nozzle with a Venturi function arranged on each of the at least two air inlets which are distributed over the periphery of the cylindrical attachment, in a manner such that fed air (L) will be introduced in a peripheral direction of the cylindrical attachment and of the funnel-shaped vessel.

2. An appliance according to claim 1, wherein each ultrasonic nozzle arranged on the air inlet is at a same axial height of the cylindrical attachment on the funnel-shaped vessel.

3. An appliance according to claim 1, wherein each ultrasonic nozzle comprises:
an outlet which has a cross section which deviates from the circular shape.

4. An appliance according to claim 3, wherein the cross section of the outlet of the ultrasonic nozzle is configured in a rectangular manner.

5. An appliance according to claim 1, wherein each ultrasonic nozzle comprises:
a narrowest throughflow cross section which is changeable.

6. An appliance according to claim 5, wherein the narrowest throughflow cross section of each ultrasonic nozzle is mechanically adjustable via adjusting screws.

7. An appliance according to claim 5, wherein the narrowest throughflow cross section of each ultrasonic nozzle is automatically adjustable via a servomotor.

8. An appliance according to claim 7, wherein the narrowest throughflow cross section of each ultrasonic nozzle is configured to be controllably adjustable in dependence on applied material (M) which is to be reduced in size, wherein control data for adjustment of the narrowest throughflow cross section of the ultrasonic nozzle is stored in an external control unit.

9. An appliance according to claim 8, wherein stored control data for adjusting the narrowest throughflow cross section of the ultrasonic nozzle is empirical data.

10. An appliance according to claim 8, wherein the control unit comprises:
an electronic data processing facility.

11. An appliance according to claim 1, wherein each ultrasonic nozzle on the air inlet of the cylindrical attachment comprises:
an air guidance plate which is assembled on the air inlet for delimiting the ultrasonic nozzle.

12. An appliance according to claim 11, comprising:
an assembly plate, wherein the air guidance plate is connected to the assembly plate.

13. An appliance according to claim 12, wherein the air guidance plate and the assembly plate are rigidly connected to an outlet of an associated nozzle body of the ultrasonic nozzle.

14. An appliance according to claim 12, wherein the nozzle body of each ultrasonic nozzle is configured to be assembled in a manner rotated by 180° with respect to the assembly plate.

15. An appliance according to claim 1, comprising:
a control device configured to be connected to a global computer network, for providing operating parameters of the appliance to be remotely read and for remote control of the appliance.

16. An appliance according to claim 1, comprising:
three or more ultrasonic nozzles arranged on the periphery of the cylindrical attachment at a same angular distance to one another.

17. An appliance according to claim 2, wherein each ultrasonic nozzle comprises:
an outlet which has a cross section which deviates from the circular shape.

18. An appliance according to claim 4, wherein each ultrasonic nozzle comprises:
a narrowest throughflow cross section which is changeable.

19. An appliance according to claim 18, wherein the narrowest throughflow cross section of each ultrasonic nozzle is automatically adjustable via a servomotor.

20. An appliance according to claim 19, wherein each ultrasonic nozzle on the air inlet of the cylindrical attachment comprises:
an air guidance plate which is assembled on the air inlet for delimiting the ultrasonic nozzle.
